(19) United States
(12) Patent Application Publication
(10) Pub. No.: US 2011/0000843 A1
(43) Pub. Date: Jan. 6, 2011

(54) APPARATUS FOR FILTERING LIQUIDS AND RELATED FILTERING COMPONENT

(76) Inventor: Giovanni Costantini, Thiene (IT)

Correspondence Address: COLEMAN SUDOL SAPONE, P.C., 714 COLORADO AVENUE, BRIDGE PORT, CT, 06605-1601, US

(21) Appl. No.: 12/736,124

(22) PCT Filed: Mar. 10, 2009
(86) PCT No.: PCT/EP2009/001700

§ 371 Date: Sep. 10, 2010

(30) Foreign Application Priority Data
Mar. 12, 2008 (IT) VI2008000061

(51) Int. Cl. B01D 29/00; C02F 1/50; B01D 29/50; B01D 39/00; B01D 35/30

(52) U.S. Cl. 210/323.1; 210/501; 210/444

(57) ABSTRACT

An apparatus for filtering liquids and the related filtering component, wherein the apparatus includes a head detachably associated to a container that accommodates a mechanically-acting filtering component; the head is provided with an inlet for the liquid to be filtered, which is connected to the portion of the container upstream of the filtering component, and with an outlet for the filtered liquid, which is connected to the portion of the container downstream of the filtering component. The apparatus has an antimicrobial structure.

The present invention relates to an apparatus for filtering liquids and to the related filtering component.

As is known, various types of filtration system, conceived to remove sediments, sand and other suspended particles entrained along the piping network of water supply systems, are commercially available.

The conventional systems protect the water systems from pitting and other damage and are also used to improve the organoleptic characteristics of water by retaining organic and inorganic substances.

Particularly widespread are the apparatuses substantially made by a container provided with an inlet for the liquid to be filtered, connected to the upstream portion of a filter inserted in the container, and with an outlet for the filtered liquid, connected to the portion of the container that lies downstream of the filter.

The filters are generally constituted by replaceable cartridges, in which the filtration means can vary according to the degree of retention that is required and to the field of use.

Specifically, when a high degree of retention is required, the preferred filters are those capable of performing deep filtration, in which the filtering barrier is of the type of a wound yarn or is constituted by a flock of synthetic fibers or by a cloth of nonwoven fabric.

However, those systems are not free from drawbacks, because in practice they do not allow to obtain microbiologically safe water.

By retaining bacteria and, other pathogen germs, the filters can in fact be easily colonized, rendering the water that passes through them a possible vehicle of infections.

The aim of the invention is to solve the problems described above, providing an apparatus for filtering liquids and a related filtering component that are capable of performing deep filtration and of reducing pathogen germs to such a level that the treated water is microbiologically safe.

Within the scope of this aim, a particular object of the invention is to provide an apparatus for filtering liquids and a corresponding filtering component that have a broad-spectrum antimicrobial activity.

A further object of the invention is to provide an apparatus for filtering liquids that offers high safety in use.

A further object of the invention is to provide an apparatus for filtering liquids and a related filtering component that have a high permanence of their antimicrobial properties.

A further object of the invention is to provide an apparatus for filtering liquids and a related filtering component that are advantageous from a purely economic standpoint.

This aim, these objects and others that will become better apparent hereinafter are achieved by an apparatus for filtering liquids, comprising a head and a detachable container that accommodates a mechanically-acting filtering component, said head being provided with an inlet for the liquid to be filtered, which is connected to the portion of said container upstream of said filtering component, and with an outlet for the filtered liquid, which is connected to the portion of said container downstream of said filtering component, characterized in that said apparatus has a structure made of antimicrobial material.

According to a further aspect, the present invention provides a filtering component related to an apparatus for filtering liquids, which can be accommodated within a container that can be detachably associated with a head provided with an inlet for the liquid to be filtered, which is connected to the portion of said container upstream of said filtering component, and with an outlet for the filtered liquid, which is connected to the portion of said container downstream of said filtering component, characterized in that said filtering component comprises a deep filtration barrier that is at least partially made of antimicrobial material.

Further characteristics and advantages will become better apparent from the description of preferred not exclusive embodiments of an apparatus for filtering liquids and of a corresponding filtering component according to the invention, illustrated by way of non-limiting example in the accompanying drawings, wherein:

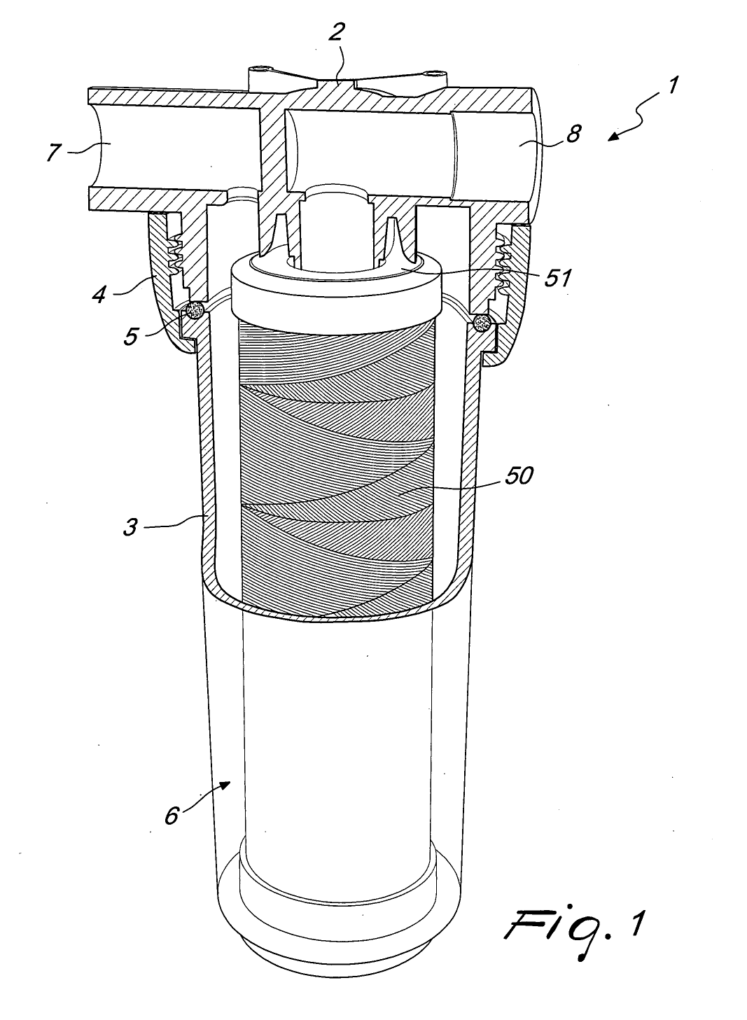

FIG. 1 is a partially sectional front view of an apparatus for filtering liquids and a related filtering component according to the invention;

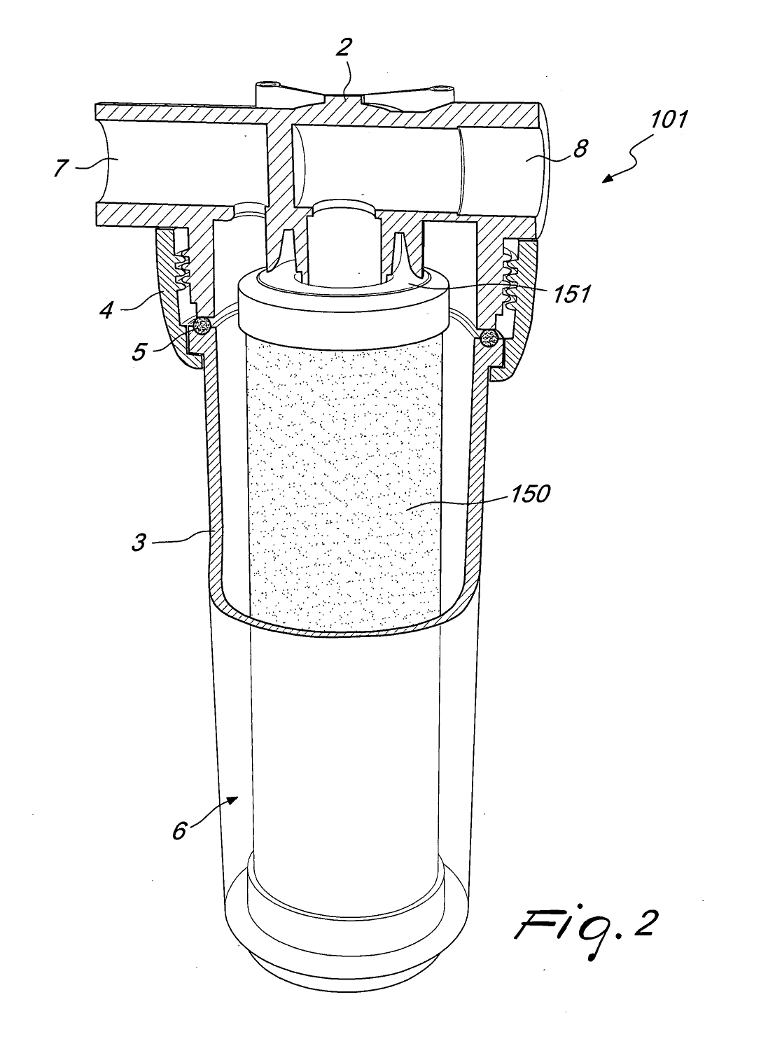

FIG. 2 is a partially sectional front view of another apparatus for filtering liquids and of a corresponding filtering component according to the invention;

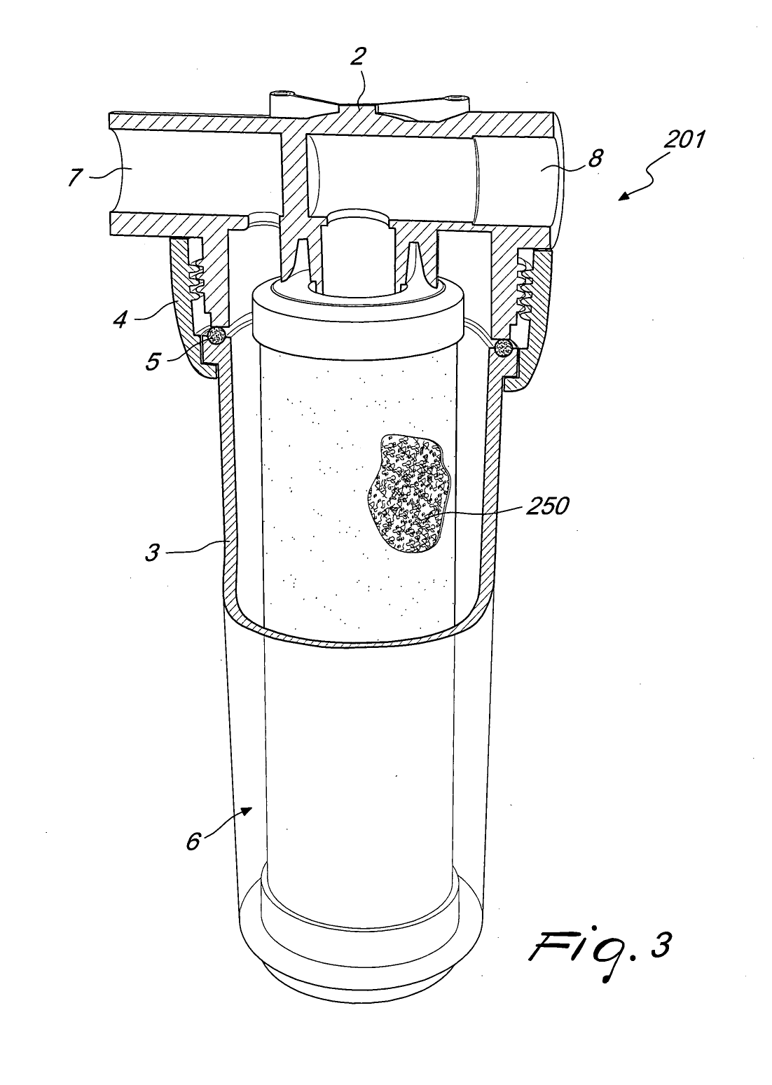

FIG. 3 is a partially sectional front view of another apparatus for filtering liquids and of a corresponding filtering component according to the invention.

With reference to FIG. 1, the apparatus for filtering liquids according to the invention, globally designated by the reference numeral 1, comprises a head 2, which is made of synthetic material, below which it is possible to associate, by means of a closure ring 4, a container 3 provided with a sealing O-ring 5.

The container 3 is preferably made of transparent synthetic material. A mechanically-acting filtering component 6 is arranged within the container 3 and is constituted by a cylindrical cartridge, which is per se already known and is provided with a deep filtering barrier 50, which is crossed by the liquid to be filtered.

In the specific case, the deep filtering barrier 50 is substantially formed by a yarn of synthetic fibers, for example polypropylene, which is wound in a spiral on a hollow core 51 according to a precise pattern that allows to optimize the degree of filtration and the capacity to accumulate impurities.

The head 2 is provided with a vent valve, not shown in the accompanying figures, and is provided with an inlet 7 for the liquid to be filtered, which is connected to the portion of the container 3 upstream of the filtering component 6, and with an outlet 8 for the filtered liquid, which is connected to the portion of the container 3 downstream of the filtering component 6.

In addition to the configuration described above, the apparatus for filtering liquids according to the invention can have a multiple configuration, not shown in the accompanying figures, in which the head is designed so that it can accommodate a plurality of filtering components that are substantially similar to the filtering component 6.

According to the invention, the structure of the apparatus for filtering liquids 1 is at least partly made of antimicrobial material.

In the specific case, the antimicrobial material substantially consists of a compound that is constituted by ions of silver, a metal that is already known for its high antibacterial properties, and by inert material, which is highly compatible with most polymers.

In practice, a variable quantity of antimicrobial material can be included in the head 2, in the container 3 and in the filtering component 6, by adding the antimicrobial material to the polymers used for their production.

According to a further aspect, the present invention in fact provides a filtering component 6 in which the deep filtering barrier 50, and optionally the hollow core 51, are at least partly made of antimicrobial material.

As regards the deep filtering barrier 50, the antimicrobial material can be incorporated in all the synthetic fibers of the yarn that composes it or only in some of them.

In a constructive variation shown in the accompanying FIG. 2, in which the apparatus for filtering liquids according to the invention has been globally designated by the reference numeral 101, the deep filtration barrier 150 is substantially formed by a cloth made of nonwoven fabric obtained from synthetic fibers, for example polypropylene, wound onto a hollow core 151.

In this case also, a variable quantity of antimicrobial material can be incorporated in the filtering component 6, by adding it to the polymers used to manufacture the deep filtration barrier 150 and optionally the hollow core 151.

In a further constructive variation shown in the accompanying FIG. 3, in which the apparatus for filtering liquids according to the invention has been globally designated by the reference numeral 201, the deep filtering barrier 250 is substantially formed by a flock that is composed of synthetic fibers, for example polypropylene.

A variable quantity of antimicrobial material can be incorporated in the filtering component 6, adding it to the polymers used to produce the deep filtering barrier 250.

In the constructive variations shown in FIGS. 2 and 3, the components that correspond to the components that have already been described with reference to the embodiment shown in FIG. 1 have been designated by the same reference numerals.

The operation of the apparatus according to the invention is as follows.

The apparatus for filtering liquids, designated respectively by the reference numerals 1, 101 and 201 performs a deep filtration, through the filtering component 6, removing sediments, sand and other suspended particles from the liquid to be filtered.

The liquid to be filtered that enters through the inlet 7, striking the internal surfaces of the head 2 and of the container 3, and impregnating the deep filtering barrier, designated respectively by the reference numerals 50, 150 and 250, is subjected to a powerful antimicrobial action.

The antimicrobial material performs an antibacterial action because the bacteria come into contact with the surfaces and the fibers of the structure.

The silver ions act on the microbes and apply both a bactericidal action, i.e., an action that causes the death of bacteria, and a bacteriostatic action, i.e., an action capable of inhibiting their proliferation.

In practice it has been found that the apparatus for filtering liquids and the corresponding filtering component according to the invention fully achieve the intended aim, performing a deep filtration and reducing pathogen germs to such a level that the treated water is microbiologically safe; this concept has an importantly validity for the necessary bacteriostatic activity in stagnant water conditions.

Specifically, the apparatus for filtering liquids according to the invention and the related filtering component, are economic and offer a high safety in use and ensure a broad-spectrum antimicrobial activity that is permanent over time.

The apparatus for filtering liquids and the related filtering component thus conceived are susceptible of numerous modifications and variations, all of which are within the scope of the inventive concept; all the details may furthermore be replaced with other technically equivalent elements.

In practice, the materials used, so long as they are compatible with the specific use, as well as the contingent shapes and dimensions, may be any according to the requirements and the state of the art.

This application claims the priority of Italian Patent Application No. VI2008A000061, filed on Mar. 12, 2008, the subject matter of which is incorporated herein by reference.

1. An apparatus for filtering liquids, comprising a head and a detachable container that accommodates a mechanically-acting filtering component, said head being provided with an inlet for the liquid to be filtered, which is connected to the portion of said container upstream of said filtering component, and with an outlet for the filtered liquid, which is connected to the portion of said container downstream of said filtering component, wherein said apparatus has a structure made of antimicrobial material.

2. The apparatus for filtering liquids according to claim 1, wherein said structure made of antimicrobial material comprises said head, said head being at least partially made of antimicrobial material.

3. The apparatus for filtering liquids according to claim 1, wherein said head accommodates a plurality of said filtering components, said apparatus for filtering liquids having a multiple configuration.

4. The apparatus for filtering liquids according to claim 1, wherein that said structure made of antimicrobial material comprises said container, said container being at least partially made of antimicrobial material.

5. The apparatus for filtering liquids according to claim 1, wherein said structure made of antimicrobial material comprises said filtering component, said filtering component being at least partially made of antimicrobial material.

6. A filtering component related to an apparatus for filtering liquids, which can be accommodated within a container that can be detachably associated with a head provided with an inlet for the liquid to be filtered, which is connected to the portion of said container upstream of said filtering component, and with an outlet for the filtered liquid, which is connected to the portion of said container downstream of said filtering component, wherein said filtering component comprises a deep filtration barrier that is at least partially made of antimicrobial material.

7. The filtering component according to claim 6, wherein said deep filtration barrier comprises a plurality of fibers at least partly made of antimicrobial material, said fibers being in the form of a yarn.

8. The filtering component according to claim 6, wherein deep filtration barrier comprises a plurality of fibers that are at least partially made of antimicrobial material, said fibers being in the form of cloth.

9. The filtering component according to claim 6, wherein said deep filtration barrier comprises a plurality of fibers that are at least partly made of antimicrobial material, said fibers being in flock form.

10. The apparatus for filtering liquids according to claim 1, wherein said antimicrobial material comprises a plurality of silver ions, said antimicrobial material being antibacterial.

11. The filtering component according to claim 6, wherein said antimicrobial material comprises a plurality of silver ions, said antimicrobial material being antibacterial.
